(19) United States
(12) Patent Application Publication
(10) Pub. No.: US 2005/0110174 A1
(43) Pub. Date: May 26, 2005

(54) Method for manufacturing a light guide plate having light manipulating microstructures

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/952,686

(22) Filed: Sep. 29, 2004

(30) Foreign Application Priority Data
Nov. 21, 2003 (TW) 92132706

(51) Int. Cl. B29D 11/00; B29C 59/02

(52) U.S. Cl. 264/1.34; 264/293; 264/129

(57) ABSTRACT

A method for manufacturing a light guide plate includes the steps of: providing a hot embossing machine having a pressing head and a working table; providing and fixing a stamper to the pressing head, the stamper having microstructures in a surface thereof facing the working table; disposing a substrate on the working table; heating the substrate; and pressing the stamper onto the substrate to form light manipulating microstructures at a surface of the substrate. In this process, the substrate is heated to a state just short of fusing. Therefore the pressure applied by the stamper need not be very large. This allows greater control of the precision of stamping by the stamper. The method is particularly efficacious for fabricating large sized light guide plates, such as those used in LCD TVs and the like.

### BACKGROUND OF THE INVENTION

1. Field of the Invention

The present invention relates to a method for fabricating a light guide plate used for a liquid crystal display (LCD), and more particularly to a method for manufacturing a light guide plate having light spreading microstructures.

2. Description of the Prior Art

A typical LCD device comprises a liquid crystal display panel, and a backlight system mounted under the liquid crystal display panel for supplying light beams thereto. The backlight system mainly comprises a light source and a light guide plate. The light guide plate is made of a transparent acrylic plastic, and is used for guiding light beams received from the light source to uniformly illuminate the liquid crystal display panel.

The light source emits light beams into the light guide plate, and at least some of the light beams are liable to be totally internally reflected within the light guide plate. In order to diffuse the light beams and enable them to emit uniformly from a top surface of the light guide plate, microstructures such as protrusions, recesses or dots are formed at a bottom surface of the light guide plate.

Light guide plates having microstructures can be manufactured by two conventional methods: the printing method and non-printing method. In printing method, the microstructures are a plurality of light diffusing substances comprising titanium oxide, glass beads, or the like. A predetermined pattern of the microstructures is screen printed on the bottom surface of the light guide plate. However, in this method, the smallest possible size of each microstructure is about 300 microns, and the precision and variability of the shapes of microstructures are insufficient.

Injection molding is a typical non-printing method for mass producing light guide plates having microstructures. In this method, in general, an injection-molding machine with a stamper is used. The stamper has a machining tool with a predetermined pattern thereon. However, in this method, it is difficult to fabricate light guide plates having precise microstructures, because of the limitation of the precision of the machining tool of the stamper and because of wearing of the machining tool. This is particularly so when the light guide plate has a large surface area. If the machining precision is unsatisfactory, diffusion and high luminance of the light guide plate can be correspondingly unsatisfactory. Diffusion and high luminance are the primary requirements for good performance of a backlight system.

Furthermore, in the case of light guide plates used for LCD TVs, the injection-molding machine is enormous. An injection-molding machine for manufacturing 15-inch, 8 mm thick light guide plates weighs 450 tons. An injection-molding machine for manufacturing 17-inch, 8 mm thick light guide plates weighs more than 650 tons. The injection-molding machine is even larger and more cumbersome for larger sized light guide plates. The larger the injection-molding machine, the more difficult it is to control the precision of microstructures formed on the light guide plates.

Therefore, it is desired to provide a new method for manufacturing a light guide plate having light spreading microstructures which overcomes the above-described disadvantages of conventional processes.

### SUMMARY OF THE INVENTION

An object of the present invention is to provide a method for manufacturing a large sized light guide plate having precise light spreading microstructures.

In order to achieve the above-described object, a method in accordance with the present invention includes the steps of: providing a hot embossing machine having a pressing head and a working table; providing and fixing a stamper to the pressing head, the stamper having microstructures in a surface thereof facing the working table; disposing a substrate on the working table; heating the substrate; and pressing the stamper onto the substrate to form light manipulating microstructures at a surface of the substrate. In this process, the substrate is heated to a state just short of fusing. Therefore the pressure applied by the stamper need not be very large. This allows greater control of the precision of stamping by the stamper. The method is particularly efficacious for fabricating large sized light guide plates, such as those used in LCD TVs and the like.

Other objects, advantages, and novel features of the present invention will become more apparent from the following detailed description when taken in conjunction with the accompanying drawings.

### BRIEF DESCRIPTION OF THE DRAWINGS

FIG. 1 is a flow chart of an exemplary method for manufacturing a light guide plate having light spreading microstructures in accordance with the present invention.

FIG. 2 is a schematic, cross-sectional view of a hot embossing machine used in the method of FIG. 1, also showing a substrate placed on the hot embossing machine.

FIG. 3 is an isometric view of a stamper of the hot embossing machine of FIG. 2, showing the stamper inverted.

FIG. 4 is an isometric view of a light guide plate manufactured by the method of the present invention.

### DETAILED DESCRIPTION OF THE PRESENT INVENTION

Reference now will be made to the drawings to describe the present invention in detail.

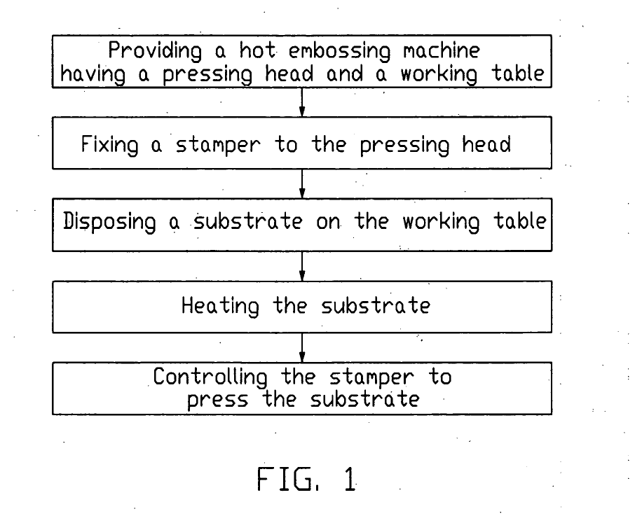

Referring to FIG. 1, a flow chart of a method for manufacturing a light guide plate having light spreading microstructures according to the present invention is shown. The steps involved in the manufacturing method are: providing a hot embossing machine having a pressing head and a working table; fixing a stamper to the pressing head; disposing a substrate on the working table; heating the substrate; and controlling the stamper to the press the substrate.

Referring to FIG. 2, in the initial step, a hot embossing machine (not labeled) is provided. The hot embossing machine includes a pressing head 41, a working table 42, and a pair of heating apparatuses 43 and 44 disposed around the working table 42. The working table 42 and the heating apparatus 43 and 44 cooperatively apply heat to a light guide plate substrate 60 attached to the working table 42. The pressing head 41 can move up and down relative to the working table 42.

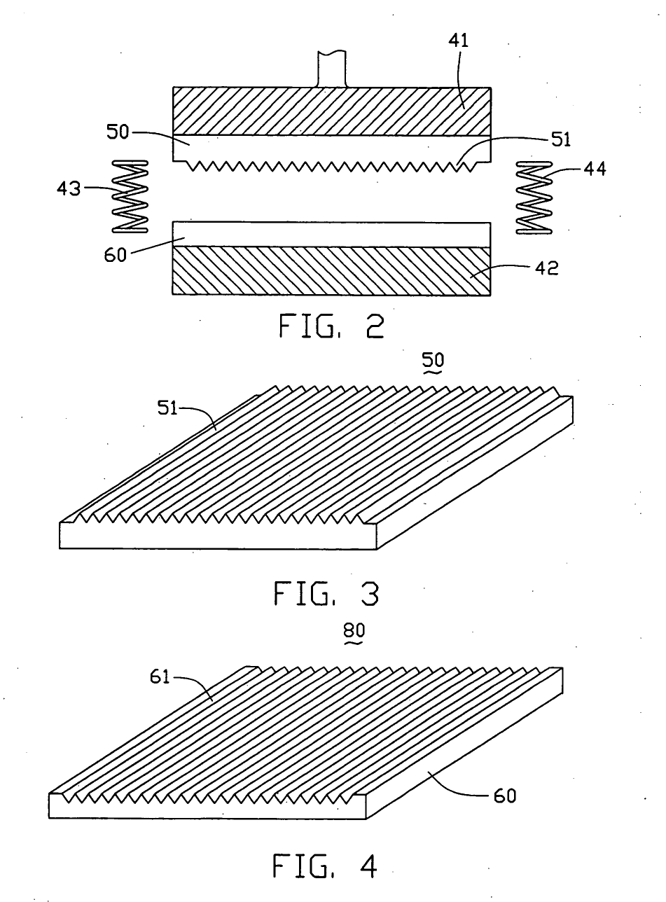

Referring also to FIG. 3, in the next step, a light guide plate stamper 50 is provided. The stamper 50 is generally a planar plate, and can be made of nickel, stainless steel, silicon, or another hard material. The stamper 50 has a pattern of microstructures 51 on a surface thereof. In this embodiment, the microstructures 51 are a plurality of V-shaped protrusions. A cross-sectional size of each microstructure is in the range from 0.05 to 40 microns. The stamper 50 is fixed to the pressing head 41 by vacuum adsorption, static adsorption, or another suitable means, such that the microstructures 51 face the working table 42.

Referring also to FIG. 4, the light guide plate substrate 60 is disposed on the working table 42 by vacuum adsorption, static adsorption, or another suitable means. A working surface (not labeled) of the substrate 60 faces the microstructures 51. The substrate 60 can be made of a resin material, such as polymethyl methacrylate or polyurethane.

In the next step, the substrate 60 is heated by the working table 42 and the heating apparatuses 43 and 44. The substrate 60 is heated to and held at a temperature just short of a temperature at which the substrate 60 fuses or melts. That is, the temperature is controlled such that the substrate 60 is in a solid state just short of fusing.

In the final step, the pressing head 41 is driven down toward the working table 42. The stamper 50 presses the substrate 60 according to a predetermined pressure, such that the microstructures 51 of the stamper 50 press into the working surface of the substrate 60 and transfer the pattern of the microstructures 51 to the working surface of the substrate 60. Once the substrate 60 is cooled, a plurality of V-shaped grooves 61 is formed on the working surface of the substrate 60 (see FIG. 4). Because the substrate 60 is heated to a state just short of fusing, the predetermined pressure applied by the stamper 50 need not be very large. This allows greater control of the precision of stamping by the stamper 50. Therefore the method is particularly efficacious for fabricating large sized light guide plates, such as those used in LCD TVs and the like.

The method preferably further includes the step of coating reflective films on side surfaces of the substrate 60. For example, films may be coated on four side surfaces of the substrate 60 adjacent to the working surface thereof.

The shape and size of the microstructures 51 of the stamper 50 can be varied according to the particular pattern of microstructures required for the working surface of the substrate 60. The microstructures 51 may be any of various kinds of protuberances, convexities, voids, or concavities. For example, the microstructures 51 can be rectangular, cylindrical, hemispherical, pyramidal, etc.

Unlike with conventional processes, in the method of the present invention, formation of the shapes and sizes of the microstructures of the working surface of the substrate 60 can be precisely controlled, particularly in the case of large sized substrates 60 to be used as light guide plates.

It is to be understood, however, that even though numerous characteristics and advantages of the present invention have been set forth in the foregoing description, together with details of the function of the invention, the disclosure is illustrative only, and changes may be made in detail to the full extent indicated by the broad general meaning of the terms in which the appended claims are expressed.

1. A method for manufacturing a light guide plate, comprising the steps of:
providing a hot embossing machine having a pressing head and a working table;
providing and fixing a stamper to the pressing head, the stamper having microstructures on a surface thereof facing the working table;
disposing a substrate on the working table;
heating the substrate; and
pressing the stamper onto the substrate to form light manipulating microstructures at a surface of the substrate.

2. The method for manufacturing a light guide plate as claimed in claim 1, wherein a cross-sectional size of each of the microstructures is in the range from 0.05 to 40 microns.

3. The method for manufacturing a light guide plate as claimed in claim 1, wherein the working table is used for heating the substrate.

4. The method for manufacturing a light guide plate as claimed in claim 3, wherein the hot embossing machine further comprises at least one heating apparatus disposed adjacent to at least one side of the substrate for heating the substrate.

5. The method for manufacturing a light guide plate as claimed in claim 4, wherein the substrate is heated up to and held at a temperature where the substrate is in a solid state just short of fusing.

6. The method for manufacturing a light guide plate as claimed in claim 1, wherein the substrate is made of a resin material.

7. The method for manufacturing a light guide plate as claimed in claim 6, wherein the resin material is polymethyl methacrylate.

8. The method for manufacturing a light guide plate as claimed in claim 6, wherein the resin material is polyurethane.

9. The method for manufacturing a light guide plate as claimed in claim 1, further comprising the step of coating one or more reflective films on one or more other surfaces of the substrate.

10. The method for manufacturing a light guide plate as claimed in claim 1, wherein the microstructures are a plurality of V-shaped protrusions.

11. The method for manufacturing a light guide plate as claimed in claim 1, wherein the microstructures are a plurality of voids or concavities.

12. The method for manufacturing a light guide plate as claimed in claim 1, wherein the microstructures are a plurality of protruberances or convexities.

13. The method for manufacturing a light guide plate as claimed in claim 12, wherein each of the protruberances or convexities is rectangular.

14. The method for manufacturing a light guide plate as claimed in claim 12, wherein each of the protruberances or convexities is cylindrical.

15. The method for manufacturing a light guide plate as claimed in claim 12, wherein each of the convexities is hemispherical.

16. The method for manufacturing a light guide plate as claimed in claim 12, wherein each of the protruberances or convexities is pyramidal.

17. A method for manufacturing a light guide plate, comprising the steps of:
heating a side area of a raw substrate of said light guide plate to a predetermined temperature; and
embossing a microstructure pattern on said heated side area of said substrate.

18. The method as claimed in claim 17, wherein said microstructure pattern includes one of a plurality of protruberances and a plurality of convexities.

19. The method as claimed in claim 17, wherein said predetermined temperature is a critical temperature at which said substrate is about to melt.

20. A method for manufacturing a light guide plate, comprising the steps of:
heating uniformly a raw substrate of said light guide plate to a predetermined temperature; and
moving a stamper with a microstructure pattern thereon toward said heated substrate to assure of a pressured contact between said pattern and said heated substrate.
